(19) United States
(12) Patent Application Publication
(10) Pub. No.: US 2019/0247271 A1
(43) Pub. Date: Aug. 15, 2019

(54) Dual Action, Single Motor Massager

(71) Applicant: Pado, Inc., Valencia, CA (US)

(72) Inventors: Steven Lee, Valencia, CA (US); Alejandro Garfio, Mission Viejo, CA (US); Travis Frye, Burbank, CA (US)

(73) Assignee: Pado, Inc., Valencia, CA (US)

(21) Appl. No.: 16/271,818

(22) Filed: Feb. 9, 2019

Related U.S. Application Data
(60) Provisional application No. 62/631,395, filed on Feb. 15, 2018.

(51) Int. Cl. A61H 23/02; A61H 23/00

(52) U.S. Cl. CPC A61H 23/0263; A61H 23/006; A61H 2201/1454; A61H 2201/1436; A61H 2201/1445

(57) ABSTRACT

A personal massage apparatus employs a single motor to selectively provide the dual action of either a vibrating massage or a percussive massage. Two sprag bearings are mounted on the drive shaft of the electric motor, with the sprag bearings being oriented such that the first sprag bearing is driven when the drive shaft rotates counter-clockwise, and the second sprag bearing is driven when the drive shaft rotates clockwise. The first sprag bearing has an eccentric weight coupled thereto such that vibration for a vibrational massage is caused when the motor rotates counter-clockwise. The second sprag bearing has crankshaft and crank pin coupled thereto, driving a connecting rod in reciprocating motion to drive a percussive massage head when the motor rotates clockwise. A counterbalance on the crankshaft minimizes vibration when the percussion action is selected.

### CROSS-REFERENCE TO RELATED APPLICATIONS

This application claims priority from U.S. Provisional Patent Application No. 62/631,395 filed Feb. 15, 2018.

### BACKGROUND OF THE INVENTION

### 1. Field of the Invention

This invention relates to the field of massagers. More particularly, this invention relates to the field of a personal massager having a single motor that provides both a percussion massage and a vibrating massage.

### 2. Description of Related Art

Electric powered hand-held personal vibrating massage appliances or “massagers” are well known in the art. Such massagers provide both therapeutic value and relaxation to the user. Most personal massagers in the past have been vibrating massagers in which the device vibrates, and the vibration is transferred to the user through a massage head. Percussion massagers are also known. Percussion massagers feature a reciprocating action. A massage head is driven in a reciprocating manner to repeatedly strike the user's muscles in a direction directly toward the user. Personal massagers typically include a control knob or button(s) for selecting the intensity (speed) of the vibration to be delivered to the user. Personal massagers are typically used on a user's neck, shoulders, arms and legs. Conventional hand-held massagers typically provide either vibration or percussion massage, but not both. Thus, the consumer is forced to purchase two devices in order to enjoy both types of massage.

Some massage wands have been produced that have two motors and two massage heads: a first motor mounted proximate a first end of the wand for providing vibration and hence driving a vibration massage head on a first end of the device, and a second motor mounted proximate the second and opposite end of the wand for providing reciprocating action and hence driving a percussive massage head on the second end of the wand.

U.S. Pat. No. 6,432,072 to Harris et al. purports to disclose a massager that provides both a pair of percussive heads as well as a vibration head, all of those heads being driven by a single motor. In the Harris device, the percussion heads are always reciprocating whenever the device is on, and the inherent vibration caused by driving the percussion heads using the disclosed mechanism also provides the vibration massage. This arrangement can produce unnecessary noise when the user desires only one type of massage. Additionally, if a user only wants a percussion massage, the device is vibrating in his hand which can be both annoying and fatiguing.

### SUMMARY OF THE INVENTION

The present invention is of a massager such as a hand held personal massage wand that selectively provides either a vibration action through a vibration head, or a percussive action through a percussion head, using a single motor.

As used herein, the term “percussive massage head” means a massage head that is intended and suitable to deliver a reciprocating percussive massage to the user. Percussive massage heads commonly take the form of spheres or partial spheres of hard foam or rubber, but can take other forms. As used herein the term “vibrational massage head” means a massage head that is intended and suitable to deliver a vibrational massage to the user. Vibrational massage heads can take many forms.

In an exemplary embodiment the drive shaft that extends from the electric drive motor extends through, or is otherwise coupled to, two sprag bearings also called one-directional bearings. The electric motor is reversible, selectively turning either clockwise or counterclockwise. The first sprag bearing has an eccentric weight mounted thereto, with the sprag bearing and hence the eccentric weight rotating with the first sprag bearing when the drive shaft rotates in a first and counterclockwise direction and only when the drive shaft rotates in that counterclockwise direction.

The second sprag bearing is coupled to a crankshaft with an eccentric crank pin on the crankshaft and a rod mounted on the crank pin. The rod is connected to the percussive massage head, such that the percussive head reciprocates as the crankshaft turns. The second sprag bearing rotates when the driveshaft rotates in a second and clockwise direction and only when the drive shaft rotates in that clockwise direction. The mechanism for driving the percussion head is counterbalanced so as to minimize the vibrations and the noise produced when the percussion head is being used.

The result is that depending on which way the electric motor is driven via user selection, the device produces either vibrations for a vibrational massage or reciprocating action for a percussive massage. When only the vibration massage is selected, the reciprocating output is not driven. When the percussive massage is chosen, the vibration mechanism is not driven, although the device will nevertheless naturally vibrate somewhat due to the reciprocating motion.

Exemplary embodiments of the invention will be further described below with reference to the drawings, in which like numbers refer to like parts. The drawing figures might not be to scale, and certain components may be shown in generalized or schematic form and identified by commercial designations in the interest of clarity and conciseness.

### BRIEF DESCRIPTION OF THE DRAWINGS

FIG. 1 is an exploded view of a dual-action, single-motor massager according to an exemplary embodiment of the invention.

FIG. 2 is an oblique closeup view of the electric motor, the two sprag bearings, and the percussion shaft of the massager of FIG. 1.

FIG. 3 is an oblique exploded view of the motor, sprag bearings, and percussion shaft shown in FIG. 2.

FIG. 4 is an oblique view of the motor, sprag bearings, and percussion shaft shown in FIG. 3, with directional arrows added to illustrate the respective directional rotations of the sprag bearings.

FIG. 5 is a closeup of the user controls of the massager of FIG. 1.

### DETAILED DESCRIPTION OF THE PREFERRED EMBODIMENTS

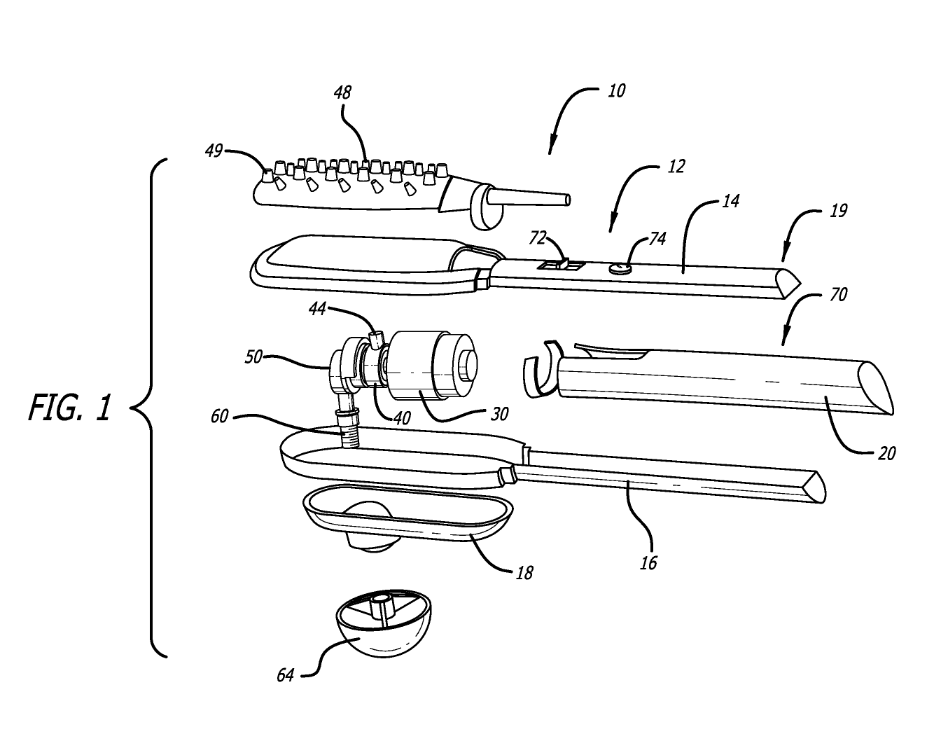

FIG. 1 is an exploded view of a dual-action, single-motor massager according to an exemplary embodiment of the invention. In this embodiment the massager 10 includes a housing 12 that includes a top housing portion 14 and a bottom housing portion 16. A bottom cover 18 has a hole therethrough through which percussion rod 60 extends, with percussive massage head 64 being mounted to percussion rod 60 such as by a thread on the end of percussion rod 60. Vibrational massage head 48 and percussive massage head 64 are mounted on opposite sides of housing 12, and on opposite sides of motor 30.

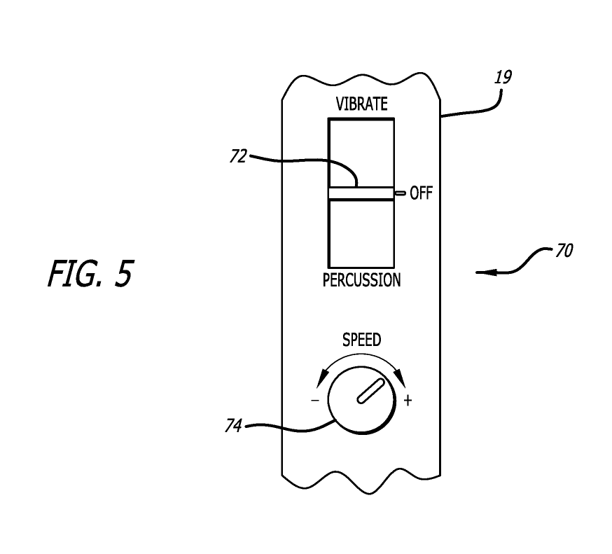

A battery housing 20 is held between the top and bottom housing portions 14, 16. A reversible electric motor 30 is mounted on one end to battery housing 20 or other supporting structure. User-operated controls 70 which are shown in greater detail in FIG. 5 allow a user to selectively control the motor 30 to turn in either a clockwise direction or a counter-clockwise direction and to adjust the motor speed thereby adjusting the intensity of the massage delivered to the user. The user-operated controls are electrically connected to a controller circuit (not shown) that drives the motor.

Reversible DC electric motors and their control circuits are well known. To implement the reversing function, control circuits typically reverse the polarity of voltage applied to the two leads of the motor. At the heart of the polarity reversal typically lies a double position double throw (DPDT) switch or its equivalent. Appropriate power transistors supply the power output to the motor. Resistors, capacitors, and inductors are typically added for transient suppression, and diodes are typically used in the control circuit to protect against reverse voltages such as from back EMF.

Speed control circuits for DC motors are also well known. Uniform speed control from very slow to very fast may be accomplished via pulse width modulation (PWM) drive to the motor as is well known.

The user controls can include a first user control for controlling the direction of the device and hence the function, such as a three-position switch 72 (FIG. 5) having positions for VIBRATION, OFF, and PERCUSSION. The user controls can include a second user control such as a rotational dial 74 for controlling the speed of the motor.

In the preferred battery-operated embodiment, the device 10 includes one or more batteries such as mounted within handle 19 which includes top and bottom housing portions 14, 16 and battery housing 20. The battery(ies) are preferably rechargeable, chargeable either through a charging port (not shown) using a battery charger or possibly through a wireless (inductive) charging system.

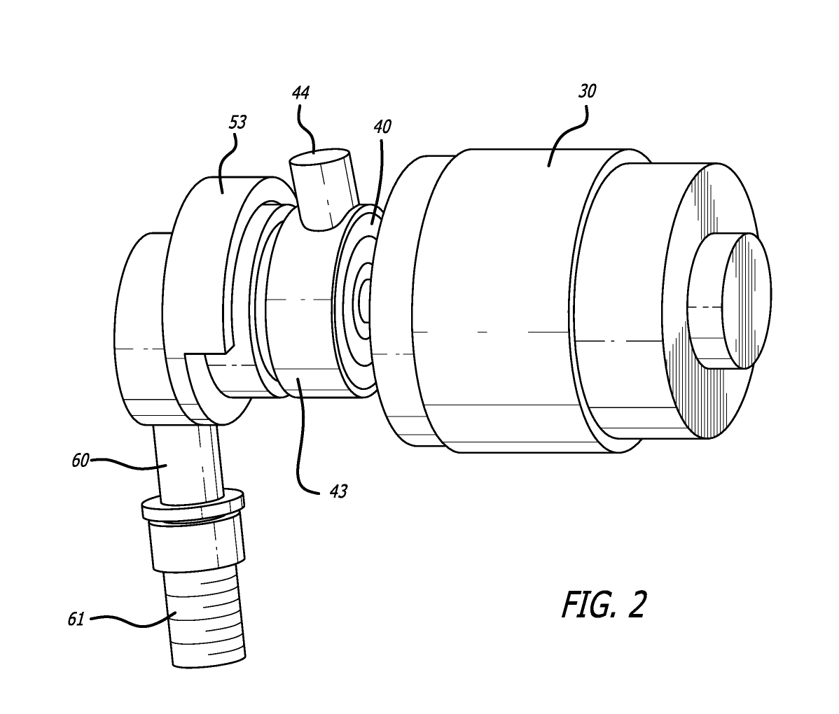

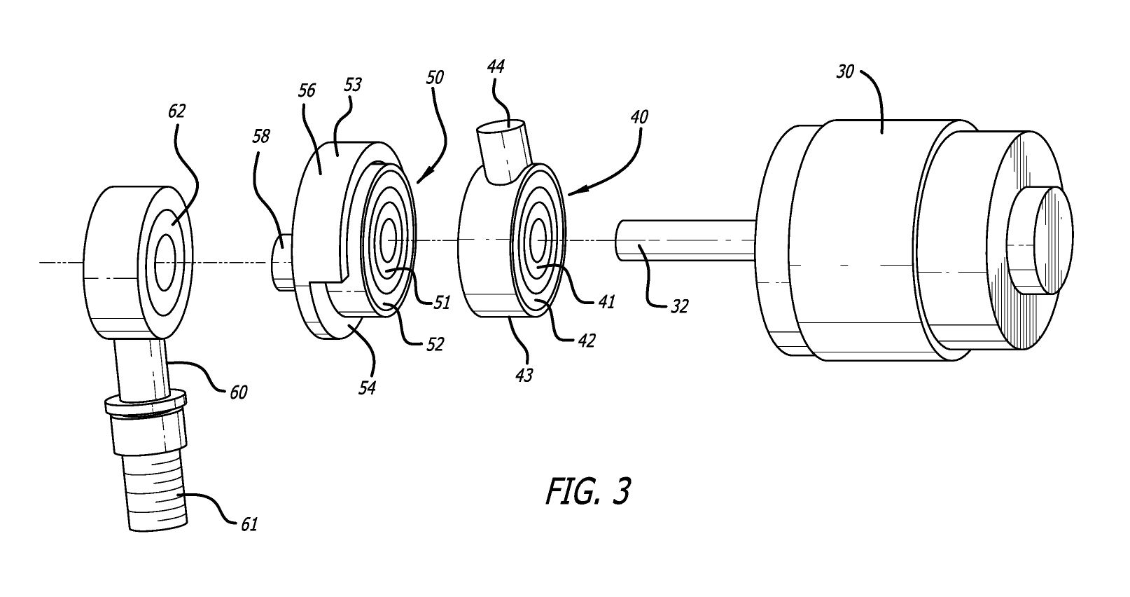

FIG. 2 is an oblique closeup view of the electric motor, the two sprag bearings, and the percussion shaft of the massager of FIG. 1, and FIG. 3 is an exploded view of the motor, sprag bearings, and percussion shaft shown in FIG. 2. Motor drive shaft 32 is driven by electric motor 30 in either rotational direction as controlled by the user.

Two sprag bearings 40, 50 are mounted to drive shaft 32 to be rotationally driven by the drive shaft. Sprag bearings are also called sprag clutches, clutch bearings, one way clutch bearings, one way bearings, and unidirectional bearings. They constitute a one-way freewheel clutch. Generally speaking, sprag bearings employ an internal clutch such that as an inner race of the sprag bearing rotates in a first direction the clutch engages thus coupling the outer race of the bearing to the inner race, and the outer race is therefore driven to rotate with the inner race. When the inner race rotates in the opposite direction, however, the clutch disengages thereby decoupling the outer race from the inner race, and thus the outer race is free to spin relative to the inner race.

The first sprag bearing 40 is rotationally driven when the massage selection switch 72 is in the VIBRATE position and motor 30 and drive shaft 32 rotate in the counter-clockwise direction, but not when they rotate in the clockwise direction. That is, as inner race 41 rotates counter-clockwise with the motor drive shaft 32 to which it is coupled, outer race 42 also rotates counter-clockwise; however, when inner race 41 rotates clockwise outer race 42 does not rotate. It is thus sometimes said that a sprag bearing is driven in only one rotational direction and not in the opposite rotational direction.

The second sprag bearing 50 operates in the opposite direction: Second sprag bearing 50 is rotationally driven when electric motor 30 and drive shaft 32 rotate clockwise but not when they rotates counter-clockwise. That is, when inner race 51 rotates clockwise with motor drive shaft 32 to which it is coupled, outer race 52 also rotates clockwise; however, when inner race 51 rotates counter-clockwise outer race 52 does not rotate.

Thus, depending upon which direction the motor is turning, either the first sprag bearing 40 or the second sprag bearing 50 will be driven, but not both.

The operation of the device in the two modes, namely VIBRATE and PERCUSSION, will now be discussed in greater detail.

A first annular portion 43 is mounted to first sprag bearing 40 such that it rotates with the outer race 42 of first sprag bearing 40 when the device is in the VIBRATE mode and hence the motor is turning counter-clockwise. That is, first sprag bearing 40 is rotationally driven when drive shaft 32 rotates in the counter-clockwise direction. An eccentric weight 44 is mounted to the first annular portion 43 such that the eccentric weight is driven in circular motion when first sprag bearing 40 is being driven, thus causing vibrations in massager 10. The vibrations are transferred through top housing portion 14 to vibrational massage head 48. Vibrational massage head 48 may be changed easily by a user, such that the user can easily select from among several massage heads to deliver the vibrating massage that he prefers. Vibrating massage head 48 can have a plurality of flexible nibs 49 as shown, such as flexible rubber-like protrusions or nibs. Other massage heads are known for use in providing vibrational massage and may be used.

In contrast, when the user selects the PERCUSSION mode via massage selector switch 72 and thus motor 30 rotates in the opposite direction namely the clockwise direction, first sprag bearing 40 is not driven; instead, second sprag bearing 50 is driven, and in particular is driven in the clockwise direction along with motor 30 and drive shaft 32. A crankshaft 53 is mounted to the outer race 52 of sprag bearing 50, such that the crankshaft is driven in the clockwise direction when drive shaft 32 turns in the clockwise direction. Crankshaft 53 preferably includes a cutout portion 54 and a counterweight 56 for rotational balance in order to minimize vibration. A crank pin 58 is mounted to crankshaft 53 such that as crankshaft 53 rotates crank pin 58 is driven in circular motion. A connecting rod or shaft 60 is rotatably mounted to crank pin 58 via bearing 62 such as that as crankshaft 53 rotates, connecting rod 60 is driven in reciprocating motion. Connecting rod 60 defines a reciprocating output shaft.

A percussive massage head 48 is mounted at the end of output shaft 60, preferably by an engaging mechanism such as a thread 61 at the end of output shaft 60 so that a user can easily change percussive massage head 64 according to the user's choice.

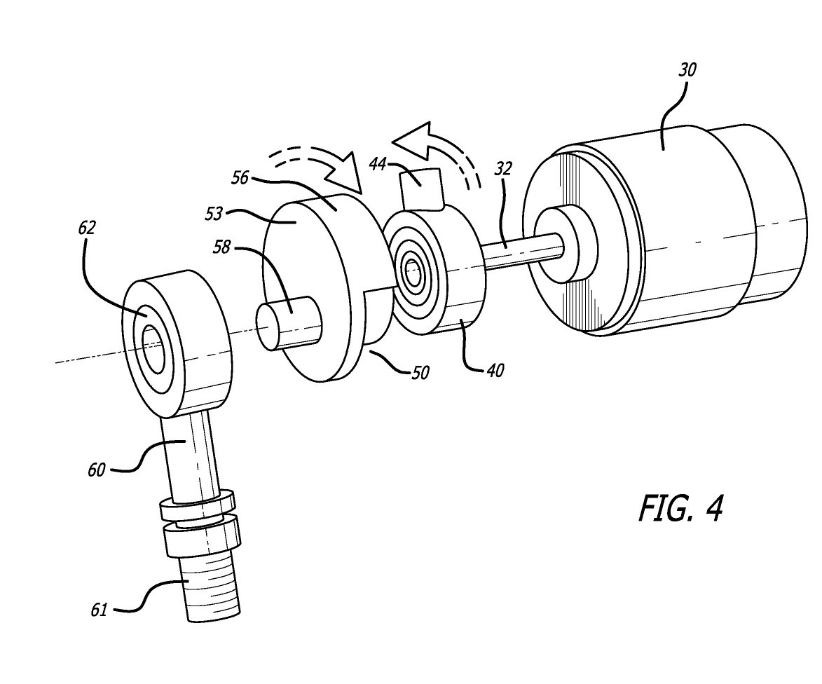

FIG. 4 is an oblique view of the motor, sprag bearings, and percussion shaft shown in FIG. 3, with directional arrows added to illustrate the respective directional rotations of the sprag bearings. When drive motor 30 and hence drive shaft 32 rotate in the counter-clockwise direction, first sprag bearing 40 is engaged and hence eccentric weight 44 is rotated and hence the massager 10 vibrates. Second sprag bearing 50 is not engaged, and hence connecting rod 60 and percussive massage head 48 are not driven.

In contrast, when drive motor 30 and hence drive shaft 32 rotate in the clockwise direction, second sprag bearing 50 is engaged and hence output shaft 60 and percussive massage 64 are driven in reciprocating motion. First sprag bearing 40 is not engaged, and hence eccentric weight 44 is not driven.

FIG. 5 is a closeup of the user controls 70 of the massager of FIG. 1. User controls 70 include a three-position massage selector switch 72 by which a user can select VIBRATE, OFF, or PERCUSSION. Switch 72 thus functions as both a massage selector switch and an ON/OFF power switch. A speed control dial 74 allows the user to control the speed of the motor and hence the frequency of the vibration and of the percussion. User controls 70 typically would provide inputs to an electrical control circuit whose outputs would actually drive the motor. The user controls 70 together with any electrical control circuit(s) for which they provide inputs define a controller for massager 10.

Preferably the electrical control circuit will automatically change the rotational speed of the motor when the rotational direction is changed. A user will typically want to use the vibrational mode and vibrational head at a higher speed, such as up to 10,000 RPM, whereas the same user will typically want to use the percussion mode and percussion head at a lower speed, such as up to 4,000 RPM. The controller therefore could control the motor such that when the user changes from vibration to percussion, the speed of the motor automatically decreases, such as by decreasing to less than half, without the user moving the speed control dial.

The device has several advantages over prior devices including the device disclosed in U.S. Pat. No. 6,432,072 to Harris et al. First, counterweight 56 provides a weight balance such that when the percussion head is activated, the device produces percussion while producing only a minimal amount of vibration, thus making the device more comfortable and less fatiguing for a user to hold the device in his hand and apply the percussive massage to his body. With proper counterweight balancing, the overall device 10 including its housing 12 can vibrate by an amount of less than 50% or even less than 25% when in the percussive mode as compared to when it is in the vibrating mode for the same total energy provided to motor 30, as measured by either the amplitude of vibration displacement or the root mean square of the vibration displacement.

Second, when the user desires only a vibrating massage, the percussive massage head 64 and the reciprocating action are not activated so the devices is quieter. It also draws less electrical energy which is important in a battery-operated device. Similarly, in the percussion mode because the percussion portion of the device is counterbalanced and the device does not vibrate significantly, energy is not needlessly lost in vibrating the device so the device uses less energy in that mode as well.

A dual-action, single-motor massager has thus been disclosed in which a vibrating massage is provided when the user commands the motor to turn in a first direction, and a percussive massage with reduced vibration is provided when the user commands the motor to turn in the other direction. Sprag bearings provide the means to selectively drive one type of massaging action or the other depending on which way the electric motor is turning.

The device can be applied to either humans or animals. In the figures, vibrating massage head 48 is a vibration brush. The inventors have observed that dogs and cats particularly enjoy a vibration brush, and that dogs also enjoy a gentle percussive massage. The device 10 is therefore particularly well suited for use as a pet massager.

Although the present invention has thus been described in detail with regard to the preferred embodiments and drawings thereof, it should be apparent to those skilled in the art that various adaptations and modifications of the present invention may be accomplished without departing from the spirit and the scope of the invention. For example, a different type of clutch other than a sprag bearing could be used to selectively drive the vibration-causing device and the reciprocating shaft that drives the percussion head. Additionally, the vibrating mechanism could be coupled more directly to the vibration massage head, such that the vibration is caused mostly in the vibration massage head and less in the overall massager 10 than in the illustrative embodiment.

Accordingly, it is to be understood that the detailed description and the accompanying drawings as set forth hereinabove are not intended to limit the breadth of the present invention, which should be inferred only from the following claims and their appropriately construed legal equivalents.

It will further be understood that terms such as “top,” “bottom,” “above,” and “below” as used within the specification and the claims herein are terms of convenience that denote the spatial relationships of parts relative to each other rather than to any specific spatial or gravitational orientation. Thus, the terms are intended to encompass an assembly of component parts regardless of whether the assembly is oriented in the particular orientation shown in the drawings and described in the specification, upside down from that orientation, or any other rotational variation.

Similarly, the terms “clockwise” and “counter-clockwise” are assigned arbitrarily for ease of discussion in providing a reference, and should not be understood as limiting either the disclosure or the claims.

We claim:

1. A massage apparatus for selectively providing either vibrational massage or percussive massage to a user, comprising:
a housing;
a first massage head attached to the housing;
a reversible motor mounted within the housing;
a controller electrically connected to the reversible motor for selectively rotating a drive shaft in a first rotational direction and in a second and opposite rotational direction;
a first sprag bearing rotationally coupled to the drive shaft, the first sprag bearing being driven to rotate in the first rotational direction when the drive shaft rotates in the first rotational direction, and not being driven to rotate when the drive shaft rotates in the second rotational direction;
a second sprag bearing rotationally coupled to the drive shaft, the first sprag bearing being driven to rotate in the second rotational direction when the drive shaft rotates in the second rotational direction, and not being driven to rotate when the drive shaft rotates in the first rotational direction;
an eccentric weight rotationally coupled to the first sprag bearing such that when the first sprag bearing rotates the eccentric weight experiences circular motion thereby causing vibration of the first massage head; and
a crank pin rotationally coupled to the second sprag bearing and a rod rotationally mounted on the crank pin, such that when the second sprag bearing rotates the rod is driven in a reciprocating motion for driving a percussive massage head;
whereby:
when the motor is driven in the first rotational direction the first sprag bearing rotates and the eccentric weight moves in a circular motion thereby causing the first massage head to vibrate, and the percussive massage head is not driven in a reciprocating motion; and
when the motor is driven in the second rotational direction the second sprag bearing rotates and the percussive massage head is driven in reciprocating motion, and the eccentric weight is not driven in a circular motion.

2. The massage apparatus of claim 1 further comprising a counterbalance mounted on the second sprag bearing, the counterbalance reducing the magnitude of vibrations that would otherwise be caused by driving of the second sprag bearing and the percussive massage head.

3. The massage apparatus of claim 2 wherein when the second sprag bearing is being driven by the motor defining a percussion mode of the massage apparatus, the massage apparatus experiences less than 50% of a vibration that occurs in the massage apparatus when the first sprag bearing is being driven by the motor defining a vibration mode of the massage apparatus, as measured by a root mean square of vibration displacement distance.

4. The massage apparatus of claim 1 wherein:
the first and second sprag bearings are mounted on the drive shaft,
the eccentric weight is mounted on the first sprag bearing; and
the crank pin is mounted on the second sprag bearing.

5. The massage apparatus of claim 1 wherein:
the first massage head is disposed on a first side of the housing; and
the percussive massage head is disposed on a second and opposite side of the housing.

6. The massage apparatus of claim 1 wherein the controller automatically changes a rotational speed of the motor when a user activates a user control to change a rotational direction of the motor from the first rotational direction to the second rotational direction.

7. A massage apparatus for selectively providing either vibrational massage and percussive massage to a user, comprising:
a reversible electric motor;
a controller for selectively causing the motor to turn in either a first rotational direction or a second and opposite rotational direction;
a drive shaft coupled to the motor, the drive shaft being driven by the motor in either the first rotational direction or the second rotational direction;
a vibration mechanism;
a first clutch rotationally coupled to the drive shaft, the first clutch driving the vibration mechanism when the drive shaft rotates in the first rotational direction and not driving the vibration mechanism when the drive shaft rotates in the second rotational direction;
a second clutch rotationally coupled to the drive shaft, the second clutch driving an output shaft to reciprocate when the drive shaft rotates in the second rotational direction and not driving the output shaft to reciprocate when the drive shaft rotates in the first rotational direction.

8. The massage apparatus of claim 7 further comprising a percussive massage head, the output shaft being coupled to the percussive massage head such that the percussive massage head reciprocates when the drive shaft rotates in the second rotational direction and does not reciprocate when the drive shaft rotates in the first rotational direction.

9. The massage apparatus of claim 1 further comprising a vibrational massage head disposed on a first side of the massage apparatus, and wherein the percussive massage head is disposed on a second and opposite side of the massage apparatus.

10. The massage apparatus of claim 7 further comprising:
a crankshaft rotationally coupled to the second clutch;
a crank pin mounted to the crankshaft;
an output shaft rotationally mounted to the crank pin shaft such that as the drive shaft rotates in the second direction the crank pin moves in a circular motion thereby driving the output shaft in reciprocating motion.

11. The massage apparatus of claim 7 wherein the first and second clutches comprise unidirectional bearings.

12. The massage apparatus of claim 11 wherein the unidirectional bearings comprise sprag bearings.

13. A massage apparatus for selectively providing either vibrational massage and percussive massage to a user, comprising:
a reversible electric motor;
a drive shaft driven by the motor to rotate;
a controller for selectively causing the motor to turn in either a first rotational direction or a second and opposite rotational direction;
a percussive massage head; and
means for coupling the drive shaft to the percussive massage head such that the percussive massage head is driven in reciprocating motion when the drive shaft rotates in the second rotational direction but not when the drive shaft rotates in the first rotational direction.

14. The massage apparatus of claim 13 further comprising:
an eccentric weight; and
means for coupling the drive shaft to the eccentric weight such that the eccentric weight rotates in circular motion when the drive shaft rotates in the first rotational direction but not when the drive shaft rotates in the second rotational direction;

15. The massage apparatus of claim 14 wherein:
said means for coupling the drive shaft to the eccentric weight comprises:
a first sprag bearing mounted to the drive shaft, the first sprag bearing having an inner race and an outer race, the drive shaft being rotationally coupled to the inner race thereof and the eccentric weight being rotationally coupled to the outer race thereof; and
said means for coupling the drive shaft to the percussive massage head comprises:
a second sprag bearing mounted to the drive shaft, the second sprag bearing having an inner race and an outer race, the drive shaft being rotationally coupled to the inner race thereof;
a crank pin mounted to the outer race of the second sprag bearing; and
an output shaft coupled to the percussive massage head, the output shaft being mounted to the crank pin such that as the outer race of the second sprag bearing rotates the output shaft and the percussive massage head coupled thereto are driven in reciprocating motion.

16. The massage apparatus of claim 14 wherein:
said means for coupling the drive shaft to the eccentric weight comprises a first unidirectional bearing; and
said means for coupling the drive shaft to the percussive massage head comprises a second unidirectional bearing.

17. The massage apparatus of claim 14 further comprising a vibrational massage head disposed on a first side of the massage apparatus, and wherein the percussive massage head is disposed on a second and opposite side of the massage apparatus.

18. The massage apparatus of claim 17 wherein the vibrational massage head comprises a plurality of flexible protrusions.
